(19) United States
(12) Patent Application Publication
(10) Pub. No.: US 2012/0255468 A1
(43) Pub. Date: Oct. 11, 2012

(54) CASH MACHINE FOR THE MANAGEMENT, INSERTION OR WITHDRAWAL OF VALUABLES

(75) Inventors: Roland Muhrenberg, Lubeck (DE); Helmut Ochs, Gumpoldskirchen (AT); Marco Zander, Kiel (DE)

(73) Assignee: NOVOMATIC AG, Gumpoldskirchen (AT)

(21) Appl. No.: 13/383,365

(22) PCT Filed: Jun. 25, 2010
(86) PCT No.: PCT/IB2010/001541

§ 371 Date: Jun. 22, 2012

(30) Foreign Application Priority Data
Jul. 10, 2009 (DE) 20 2009 009 550.9

(51) Int. Cl. G07G 5/00; G07F 19/00

(52) U.S. Cl. 109/24.1

(57) ABSTRACT

A cash machine having a device housing with a first door for accessing valuables and a printer housing affixed within the device housing. The printer housing isolates the printer from the device housing. The printer housing has a second door. A printer and a paper roll mount on the second door either directly or with a holding fixture. The second door moves from a closed configuration where the door is closed to an open configuration where the door is open to enable access to the printer and the paper roll. When the second door is in the open configuration at least a portion of the printer and the printer roll extend out from the device housing to facilitate maintenance.

### CROSS-REFERENCE TO RELATED APPLICATIONS

This application claims priority under 35 U.S.C. 119(a) and 365(b) to International Patent Application No. PCT/EP2010/001541, having an international filing date of 12 Jul. 2009.

### FIELD OF THE INVENTION

The invention pertains to cash machines for handling cash and other valuables, particularly the invention pertains to cash machines equipped with a printer.

### BACKGROUND OF THE INVENTION

A cash machine is an apparatus for cash management. Cash machines include automated teller machines (ATMs), cash deposit machines and cash recycling machines. Cash machines are also known as bank machines.

Cash machines enable the customer to withdraw or deposit money from a giro or credit card account through self-service. Some machines also dispense foreign currencies or inform the customer regarding his bank balance and the past transactions. Such machines are often operated by financial institutions.

For the withdrawal of money the customer inserts a debit or credit card into the machine and typically enters a personal identification number (PIN). A central authorization office checks online whether the personal identification number is correct and decides whether the payout can be made.

Cash machines of the newer generation also allow the depositing of cash. The procedure is similar to the withdrawal; the customer typically inserts a customer card into the machine, then a cash insertion slot opens, and cash is inserted. The cash is checked for authenticity and is booked onto the customer's account. By doing so the bank can also provide the money depositing service outside the office hours to its customers and the bank saves the enormous personnel expenses of operating a night depository. If the cash machine can recycle verified paid-in money, it can be paid out to subsequent customers whereby the bank reduces the labor of filling.

Cash machines also include vending machines, laundry machines and a variety of other machines that provide products or services. Such machines are often located in public places and with the insertion of money such machines can, for example, sell drinks or snacks. In addition, ticket machines are known where following the itinerary selection and the insertion of money a ticket is printed.

Cash machines also include cash change machines or chip machines in laundries for the change of the necessary coins or chips for the washing machines. Many cash machines are also equipped with a printer for printing a receipt, ticket or statement.

During the product cycle or the operation lifetime of such machines the printer requires servicing. For example, this can be the refilling or the change of the entire printer or the print media, or also cleaning the paper feed and/or output.

US 2007/0108267 A1 shows a cash machine comprising a printer for printing of receipts. The cash machines houses money processing components in a housing to which a hinged casing door is mounted. The service access for the printer is designed so that opening of the entire device is necessary for the servicing. By opening the entire device it is possible that the servicing staff may have unauthorized access to money or other information, in particular money-processing components, of the cash machine.

Ideally cash machines facilitate service access to the printer without allowing the access to money or money processing components.

### SUMMARY OF THE INVENTION

The cash machine of the present invention manages cash, including the insertion and/or withdrawal of valuables, such as cash. The cash machine includes a device housing and a printer. The printer is affixed in a closed printer housing separated from the device housing so that the printer is accessible without the need of opening of the entire device.

With such an embodiment of the invention an increased security during servicing is given. Unauthorized access to money or money processing components by servicing personnel can be avoided during simple maintenance of the printer. The invention enables separate personnel for the printer maintenance and servicing, and for valuable collection.

According to a preferred embodiment of the invention the printer may be located in a separate opening of the device. This opening should ideally be big enough so that service and maintenance work at the printer can be performed. If the opening can be closed, vandalism and theft can be prevented. According to a preferred embodiment of the present invention the printer is placed on a holding fixture that can be swiveled out of the device.

With such an arrangement of the invented device a greater security for servicing is given, as unauthorized access to money and/or money processing components by servicing personnel is avoided, while the accessibility to the printer for maintenance purposes is guaranteed. With the recommended design of the present invention the holding fixture is like a drawer. It is possible that the printer is mounted onto the drawer-like device. By pulling the drawer it is possible to move and/or slide the printer in relation to the device housing.

It would be possible that a holding fixture i.e. drawer can be folded out. For example, if the printer is mounted inside an opening or servicing flap and, when shut, is placed vertically within the device, by the downward opening of the servicing flap the printer can be moved into a horizontal position.

It may also be possible the printer being movable out from the device by tilting and/or turning movements. The recommended design of the invention allows a closing of the holding fixture in order to avoid unauthorized access.

If a handle is placed on the holding fixture of the device according to the invention the handling may be facilitated. The invention may be a cash machine such as an ATM machine, pay machine, or a vending machine.

According to what kind of device is used it may be useful that also other components of the device, as described above, are placed in the device, such as a computer, power supply, printing paper rolls and/or printing container.

### BRIEF DESCRIPTION OF THE DRAWINGS

Various exemplary embodiments of the invention are depicted in drawings. Such embodiments are by way of example only, and are not intended to limit the scope of the invention.

FIG. 1 is a front view of the cash machine of the present invention.

FIG. 2 is a perspective view of a cash machine drawer.

FIG. 3 is a rear view of the drawer of the embodiment in FIG. 1.

FIG. 4 is a top view of the invention having a wing flap door.

FIG. 5 is a side view of the invention of FIG. 4.

### DETAILED DESCRIPTION

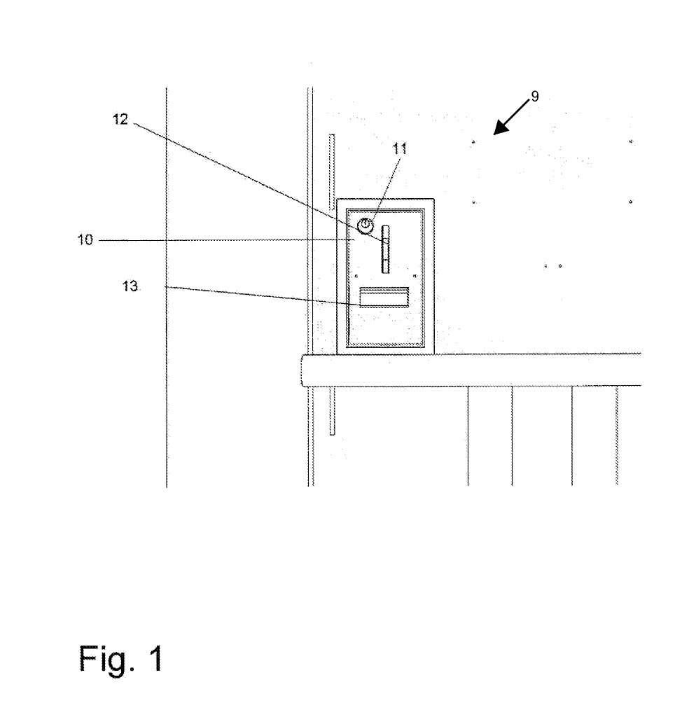

FIG. 1 shows a cash machine generally designated with the reference numeral 9. The cash machine 9 includes a door comprising a drawer 10. The drawer 10 is equipped with a lock 11, so that unauthorized opening of the drawer 10 is prevented. There is a handle 12 on the drawer to facilitate the pulling-out of the drawer 10. Furthermore, there is a receipt-issuing slot 13 in the drawer 10 so that a customer using the cash machine can receive a receipt.

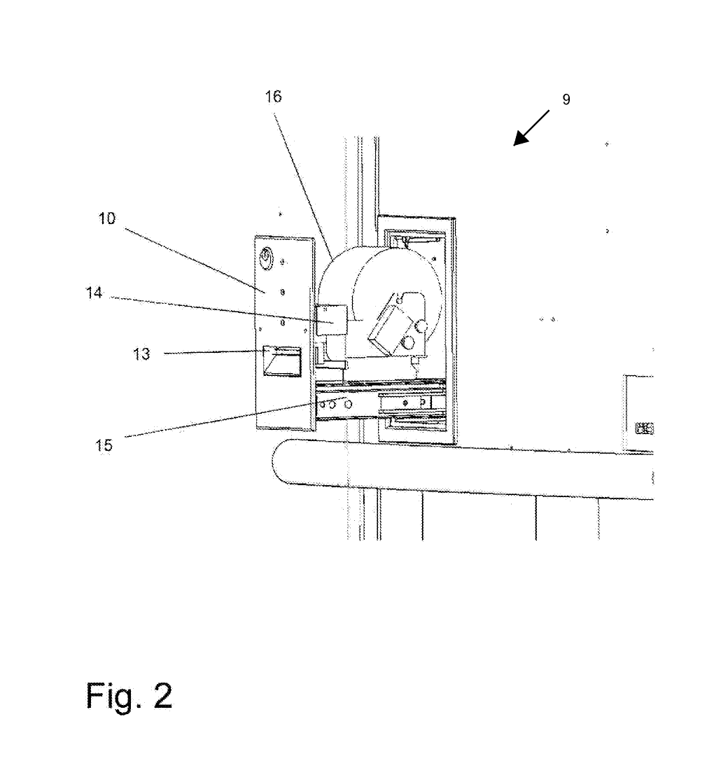

FIG. 2 shows the drawer 10 of the cash machine 9 of FIG. 1 opened. The drawer 10 includes a printer 14 mounted on telescopic rails 15 to enable the drawer to open and close. The drawer 10 shown is open. A paper roll 16 is mounted in the drawer 10 for supplying the printer 14 with paper.

Maintenance of the printer 14 includes replacement of the paper roll 16 and maintenance of the printer 14 components. Repair of the printer 14 and change of the paper roll 16 is possible without a complete opening of the cash machine in the corresponding preferred embodiment. By doing so, the cash or other valuables are not normally accessible during the printer servicing and therefore secure.

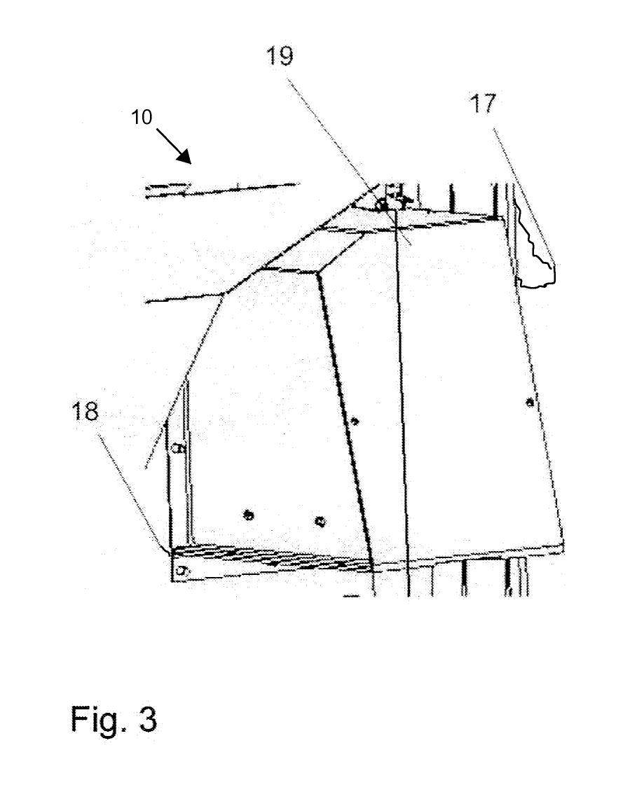

FIG. 3 shows a portion of the drawer 10 of the housing 17 including the inside of the door 18 and a printer housing 19. This printer housing 19 is designed in such a manner that the printer (not shown) is separated from the remainder of the housing 17 of the cash machine. The reference numeral 18 is the inside of the drawer 10, according to this embodiment. The printer mounts securely in the drawer.

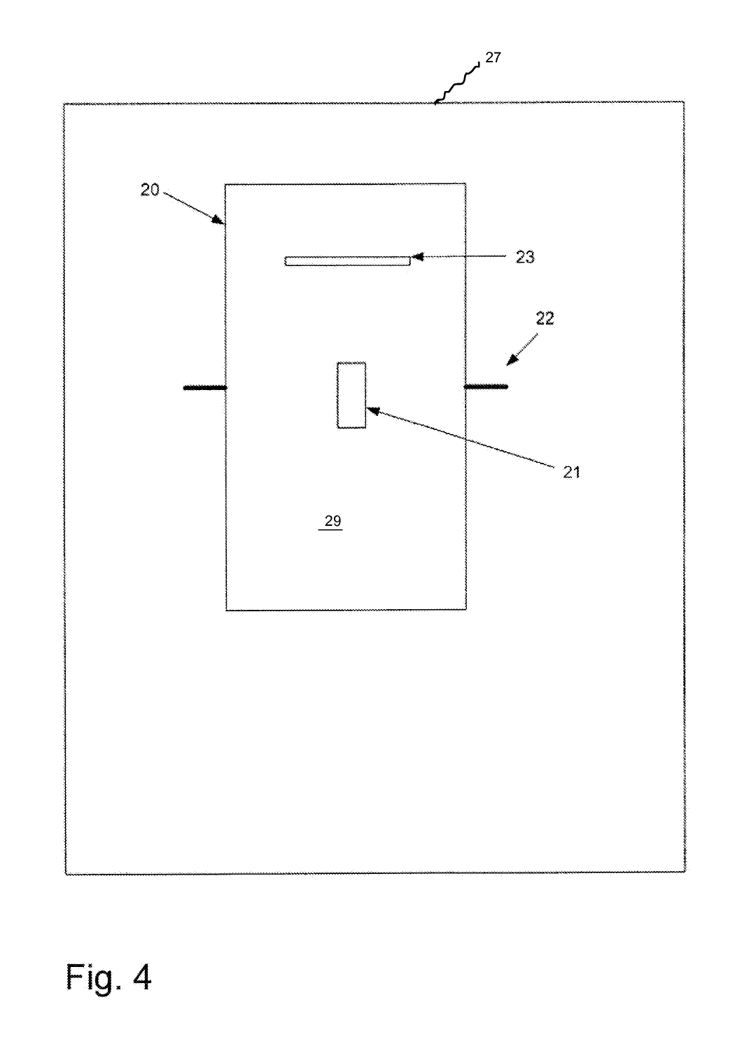

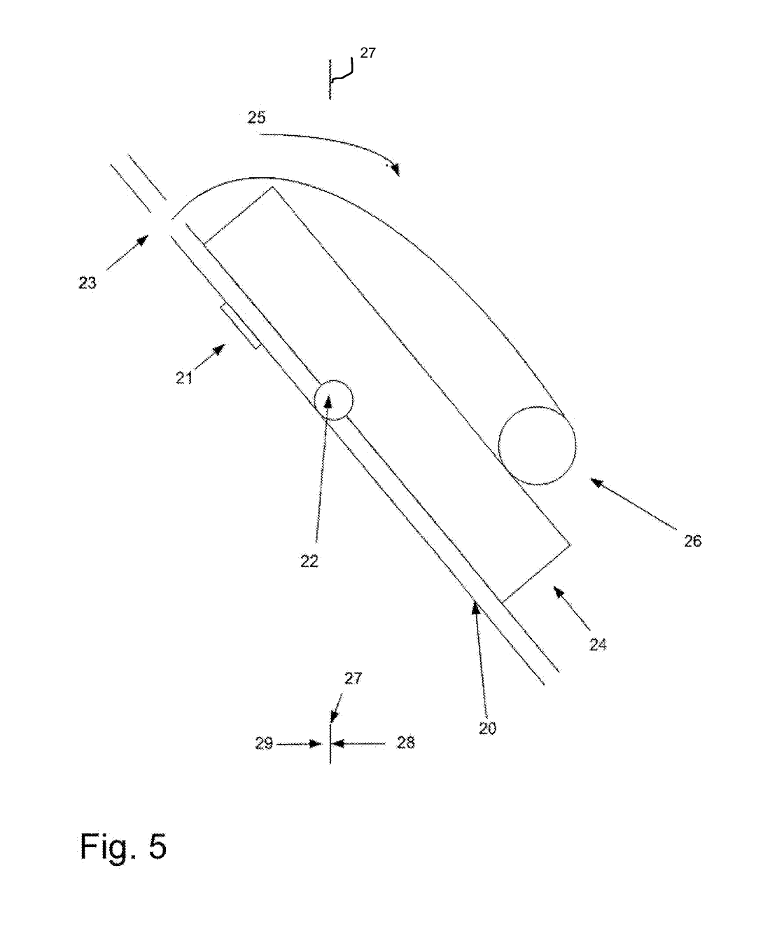

FIG. 4 shows an embodiment of the outside 29 of the door of the cash machine. The door comprises a wing flap 20. The wing flap 20 is shown in a closed configuration and pivots to an open configuration to enable access to the printer and other serviceable printer components, including the paper roll. The wing flap 20 securely mounts the printer 24 on the inside 28 (FIG. 5) of the wing flap 20.

FIG. 5 it is shown in a side view of the wing flap 20 in an open configuration and rotating about the axis 22 in direction of the arrow 25 towards a closed configuration. The axis 22 is defined centrally on the wing flap 20.

The wing flap 20 pivots around an axis 22 to enable access to the printer. The printer 24 mounts on the backside of the wing flap 20 i.e. on the inside of the door. Service and maintenance is enabled when the wing flap is in an open configuration. Upon completion of service, the wing flap 20 pivots around its axis 22 and the printer 24 can be closed in direction of the arrow 25. The printer 24 can be more readily accessed when the wing flap 20 is swiveled outwards in a direction opposite the arrow 25.

According to the preferred embodiment the wing flap 20 is foreseen at a door 27 of the cash machine. The inside of the door 27 is marked with the reference sign 28 and the outside of the door with 29. If servicing of the printer 24 is necessary only lock 21 has to be unlocked, the wing flap 20 to be pivoted outside and the printer can be serviced without the servicing personnel having access to the other functions of the device.

The wing flap 20 includes a lock 21 to prevent unauthorized opening of the wing flap 20. The wing flap 20 includes a slot 23 out of which the printed items such as receipts or tickets are dispensed from the printer 24.

Although various embodiments of the invention are illustrated and described herein, the present invention should be broadly understood and is to be limited only by the claims below.

1. A cash machine, comprising:
a device housing having a first door for accessing valuables;
a printer housing affixed within the device housing, the printer housing isolates the printer within the device housing;
the printer housing has a second door; and
a printer mounts on the second door, the second door moves from a closed configuration where the door is closed to an open configuration where the door is open to enable access to the printer.

2. A cash machine as set forth in claim 1, wherein the first door has a first locking system and the second door has a second locking system, wherein opening the second door of the printer housing does not enable access to the valuables.

3. A cash machine as set forth in claim 1, wherein the second door includes a drawer having rails to enable the door and the printer to slide into the open configuration.

4. A cash machine as set forth in claim 1, wherein the second door includes a wing flap pivotally mounted on the printer housing to enable the second door to pivot into the open configuration.

5. A cash machine as set forth in claim 4, wherein the wing flap has an axis defined centrally on the wing flap and the wing flap pivots on the axis.

6. A cash machine as set forth in claim 1, wherein the second door defines a slot for issuing a receipt.

7. A cash machine, comprising:
a device housing having a first door for accessing valuables;
a printer housing affixed within the device housing, the printer housing isolates the printer from the device housing;
the printer housing has a second door; and
a printer and a paper roll mount on the second door, the second door moves from a closed configuration where the door is closed to an open configuration where the door is open to enable access to the printer and the paper roll,
whereby, when the second door is in the open configuration the printer extends at least partially out from the device housing to facilitate maintenance.

8. A cash machine as set forth in claim 7, wherein the first door has a first locking system and the second door has a second locking system, wherein opening the second door of the printer housing does not enable access to the valuables.

9. A cash machine as set forth in claim 7, wherein the second door includes a drawer having rails to enable the second door and the printer to slide into the open configuration, enabling the printer to extend at least partially out from the device housing.

10. A cash machine as set forth in claim 7, wherein the second door includes a wing flap pivotally mounted on the printer housing to enable the door to pivot into the open configuration, enabling the printer to extend at least partially out from the device housing.

11. A cash machine as set forth in claim 10, wherein the wing flap has an axis defined centrally on the wing flap and the wing flap pivots on the axis.

12. A cash machine as set forth in claim 7, wherein the second door defines a slot for issuing a receipt.

13. A cash machine, comprising:
a device housing having a first door for accessing valuables;
a printer housing affixed within the device housing, the printer housing isolates the printer from the device housing;
the printer housing has a second door; and
a printer and a paper roll mount on the second door, the second door moves from a closed configuration where the door is closed to an open configuration where the door is open to enable access to the printer and the paper roll,
whereby, when the second door is in the open configuration the printer and the printer roll extend at least partially out from the device housing to facilitate maintenance.

14. A cash machine as set forth in claim 13, wherein the first door has a first locking system and the second door has a second locking system, wherein opening the second door of the printer housing does not enable access to the valuables.

15. A cash machine as set forth in claim 13, wherein the second door includes a drawer having rails to enable the second door and the printer to slide into the open configuration.

16. A cash machine as set forth in claim 13, wherein the second door includes a wing flap pivotally mounted on the printer housing to enable the door to pivot into the open configuration, enabling the printer to extend out from the device housing.

17. A cash machine as set forth in claim 16, wherein the wing flap has an axis defined centrally on the wing flap and the wing flap pivots on the axis.

18. A cash machine as set forth in claim 13, wherein the second door defines a slot for issuing a receipt.

19. A cash machine as set forth in claim 13, wherein the printer and the paper roll extend fully out from the first housing when the second door opens.

20. A cash machine as set forth in claim 13, wherein the printer and the paper roll mount on a holding fixture to attach the printer and paper roll to the second door.
